(19) United States
(12) Patent Application Publication
(10) Pub. No.: US 2005/0259704 A1
(43) Pub. Date: Nov. 24, 2005

(54) Laser oscillation device

(75) Inventors: Yoshiaki Goto, Itabashi-ku (JP); Masayuki Momiuchi, Itabashi-ku (JP); Taizo Eno, Itabashi-ku (JP)

Correspondence Address: NIELDS & LEMACK, 176 EAST MAIN STREET, SUITE 7, WESTBORO, MA, 01581, US

(73) Assignee: Kabushiki Kaisha TOPCON

(21) Appl. No.: 11/114,259

(22) Filed: Apr. 26, 2005

(30) Foreign Application Priority Data
May 18, 2004 (JP) 2004-147194

(51) Int. Cl. H01S 3/04; H01S 3/14

(52) U.S. Cl. 372/39

(57) ABSTRACT

A laser oscillation device, comprising an optical crystal, wherein an end surface of the optical crystal where a laser beam enters is cooled down by a gas.

### BACKGROUND OF THE INVENTION

The present invention relates to a laser oscillation device using a semiconductor laser as an excitation source.

First, description will be given on general features of a laser oscillation device 1.

FIG. 7 shows a diode-pumped solid-state laser of one-wavelength oscillation, which is an example of the laser oscillation device 1.

In FIG. 7, reference numeral 2 denotes a light emitting unit, and reference numeral 3 represents an optical resonator. The light emitting unit 2 comprises an LD light emitter 4 and a condenser lens 5. Further, the optical resonator 3 comprises a first optical crystal (a laser crystal 8) with a first dielectric reflection film 7 formed on the first optical crystal, a second optical crystal (a nonlinear optical crystal (NLO) (a wavelength conversion crystal 9)), and a concave mirror 12 with a second dielectric reflection film 11 formed on the concave mirror 12. A laser beam is pumped at the optical crystal resonator 3, and the laser beam is resonated, amplified and outputted. As the laser crystal 8, Nd:YVO₄ is used, and KTP (KTiOPO₄; titanyl potassium phosphate) is used as the wavelength conversion crystal 9.

Further, description is given as follows:

The laser oscillation device 1 projects a laser beam with a wavelength of 809 nm, for instance, and the LD light emitter 4, i.e. a semiconductor laser, is used. The LD light emitter 4 fulfills a function as a pumping light generator to generate an excitation light. In the laser oscillation device 1, the LD light emitter 4 is not limited to a semiconductor laser, and any type of light source means can be adopted so far as it can generate a laser beam.

The laser crystal 8 is used to amplify the light. As the laser crystal 8, Nd:YVO₄ with an oscillation line of 1064 nm is used. In addition, YAG (yttrium aluminum garnet) doped with Nd³⁺ ion, etc. are adopted. YAG has oscillation lines of 946 nm, 1064 nm, 1319 nm, etc. Ti (Sapphire) with an oscillation line of 700 to 900 nm, etc. may be used.

On a surface of the laser crystal 8 closer to the LD light emitter 4, the first dielectric reflection film 7 is formed. The first dielectric reflection film 7 is highly transmissive to the laser beam from the LD light emitter 4, and the first dielectric reflection film 7 is highly reflective to an oscillation wavelength of the laser crystal 8. The first dielectric reflection film 7 is also highly reflective to a secondary higher harmonic wave (SHG; second harmonic generation).

The concave mirror 12 is designed to face to the laser crystal 8. A surface of the concave mirror 12 closer to the laser crystal 8 is fabricated in form of a mirror with a concave spherical surface having an adequate radius. The second dielectric reflection film 11 is formed on the surface of the concave mirror 12. The second dielectric reflection film 11 is highly reflective to the oscillation wavelength of the laser crystal 8, and the second dielectric reflection film 11 is highly transmissive to the secondary higher harmonic wave.

As described above, when the first dielectric reflection film 7 of the laser crystal 8 is combined with the second dielectric reflection film 11 of the concave mirror 12. When the laser beam from the LD light emitter 4 is entered to the laser crystal 8 through the condenser lens 5, a light with a fundamental wave is oscillated. The oscillated light is pumped by running reciprocally between the first dielectric reflection film 7 of the laser crystal 8 and the second dielectric reflection film 11, and the light can be confined for long time. As a result, the light can be resonated and amplified.

The wavelength conversion crystal 9 is placed within the optical resonator, which comprises the first dielectric reflection film 7 of the laser crystal 8 and the concave mirror 12. When a strong coherent light such as a laser beam enters the wavelength conversion crystal 9, a secondary higher harmonic wave to double a frequency of light is generated. The generation of the secondary higher harmonic wave is called “second harmonic generation”. Therefore, a laser beam with a wavelength of 532 nm is emitted from the laser oscillation device 1.

In the laser oscillation device 1 as described above, the wavelength conversion crystal 9 is disposed within the optical resonator, which comprises the laser crystal 8 and the concave mirror 12. This is called an intracavity type SHG. Because a conversion output is proportional to a square of excitation light photoelectric power, this provides an effect to directly utilize high optical intensity within the optical resonator.

In general, a semiconductor laser does not emit a laser beam of high output. Therefore, the diode-pumped solid-state laser using the laser beam from the LD light emitter 4 as an excitation light does not provide high output. However, to fulfill a demand to have higher output in recent years, there are the LD light emitters 4 which comprise a plurality of semiconductor lasers 13.

For instance, in the laser oscillation device disclosed in the Japanese Patent Application Publication No. 2003-124553, the LD light emitter 4 comprises a plurality of semiconductor lasers 13 as shown in FIG. 8. The plurality of semiconductor lasers 13 are arranged in form of an array. The laser beams emitted from the semiconductor lasers 13 are respectively converged to corresponding optical fibers 15 via a rod lens 14, and the optical fibers 15 are bundled together to a fiber cable 16. The light is turned to an excitation light 17 with high optical intensity, and this is entered to the laser crystal 8 to achieve high output.

When the excitation light 17 is entered to the laser crystal 8, the excitation light 17 is absorbed in the laser crystal 8, and excitation oscillation occurs on an end surface of the laser crystal 8. As a result, a part of energy of the excitation light 17 not absorbed is turned to heat. For this reason, temperature rise is at the highest on the incident end surface of the laser crystal 8 in the laser oscillation device of end surface excitation type.

When optical intensity of the excitation light entering the laser crystal 8, i.e. energy density of the excitation light, is increased, temperature of the laser crystal 8—in particular, temperature of the end surface—rises locally. In addition, because the laser crystal 8 itself has low thermal conductivity, optical and mechanical distortion occurs, and this may cause the decrease of laser oscillation. Further, if distortion increases, the crystal may be destroyed.

To cope with the temperature rise of the laser crystal 8 and of the wavelength conversion crystal 9 caused by the increase of optical intensity of the excitation light, it is practiced to cool down the laser crystal 8 and the wavelength conversion crystal 9. A cooling structure as shown in FIG. 9 is disclosed in the Japanese Patent Application Publication No. 2003-124553. In FIG. 9, the same component as shown in FIG. 7 and FIG. 8 is referred by the same symbol.

The light emitting unit 2 and the optical resonator 3 are fixed on a base 19, which serves as a heat sink. The light emitting unit 2 and the optical resonator 3 are arranged on an optical axis 10 (See FIG. 5). A lens unit 21 comprising the condenser lens 5 is disposed between the light emitting unit 2 and the optical resonator 3.

An optical resonator block 22 is fixed on the base 19. The optical resonator block 22 comprises the laser crystal 8 on the optical axis 10. The concave mirror 12 is provided on a surface of the optical resonator block 22 on an opposite side to the lens unit 21.

A recess 23 is formed in the optical resonator block 22 from above, and a wavelength conversion crystal 9 held by a wavelength conversion crystal holder 24 is accommodated in the recess 23. The wavelength conversion crystal holder 24 is tiltably mounted on the optical resonator block 22 via a spherical seat 25 so that an optical axis of the wavelength conversion crystal holder 24 can be aligned with the optical axis 10. A Peltier element 26 to cool down the wavelength conversion crystal 9 is arranged on the wavelength conversion crystal holder 24.

It is composed in such manner that the heat of the laser crystal 8 is radiated from the base 19 via the optical resonator block 22, and the wavelength conversion crystal 9 is cooled down by the Peltier element 26.

The laser crystal 8 is cooled down by thermal conduction from the laser crystal 8 to the optical resonator block 22, and further from the optical resonator block 22 to the base 19. The laser crystal 8 itself has poor thermal conductivity and its mechanical strength is also low. In order to increase thermal conductivity from the laser crystal 8 to the optical resonator block 22, it is proposed to promote close fitting between the laser crystal 8 and the optical resonator block 22 via soft metal such as indium, etc.

However, the highest temperature rise of the laser crystal 8 occurs on the end surface where the excitation light 17 enters. Because the excitation light 17 has high energy and high energy density, and because the laser crystal 8 itself has low thermal conductivity, heat input amount at the incident point of the excitation light 17 on the laser crystal 8 is larger compared with heat transfer amount caused by heat conduction. As a result, by the cooling operation based on heat conduction from the laser crystal 8 to the optical resonator block 22, it is difficult to suppress temperature rise on the end surface of the laser crystal 8. The temperature at the incident point rises to high temperature and steep temperature gradient is caused between the incident point and the surrounding region.

Therefore, in the cooling system in the past based on heat conduction from the laser crystal 8 to the optical resonator block 22, it is difficult to perform sufficient cooling at the incident point of the excitation light 17 on the laser crystal 8.

### SUMMARY OF THE INVENTION

It is an object of the present invention to effectively cool down an optical crystal such as a laser crystal, a wave length conversion crystal, etc.—in particular, at an end surface where a laser beam enters.

To attain the above object, the laser oscillation device according to the present invention comprises an optical crystal, wherein an end surface of the optical crystal where a laser beam enters is cooled down by a gas. Also, the present invention provides the laser oscillation device as described above, wherein the cooling gas is spouted out to an incident point of the laser beam on the optical crystal. Further, the present invention provides the laser oscillation device as described above, wherein the cooling gas is flowed along an end surface of the optical crystal. Also, the present invention provides the laser oscillation device as described above, wherein the cooling gas is ejected through a gas injection nozzle. Further, the present invention provides the laser oscillation device as described above, wherein the optical crystal is held by a block, and a gas injection nozzle to eject the cooling gas to the end surface of the optical crystal is formed in the block. Also, the present invention provides the laser oscillation device as described above, wherein the optical crystal is cooled down by a cooling device and the cooling gas is cooled down by the cooling device. Further, the present invention provides the laser oscillation device as describe above, wherein a tilted surface to guide the gas spouted out to the end surface is formed on an opposite side of the gas injection nozzle. Also, the present invention provides the laser oscillation device as described above, wherein the laser oscillation device has an enclosed structure enclosed by a cover, the cooling gas is an atmospheric gas filled within the cover, and there is provided a cooling gas circulator to suck the atmospheric gas and to eject the gas to the end surface of the optical crystal.

According to the present invention, a laser oscillation device comprises an optical crystal, and an end surface of the optical crystal where a laser beam enters is cooled down by a gas. As a result, it is possible to suppress temperature rise on the end surface of the optical crystal where temperature rise is at the highest.

According to the present invention, the cooling gas is spouted out to the incident point of the laser beam on the optical crystal. This makes it possible to suppress temperature rise at the incident point where temperature increases locally.

According to the present invention, the optical crystal is held by a block, and a gas injection nozzle to eject the cooling gas to the end surface of the optical crystal is formed in the block. Therefore, the cooling gas ejected from the nozzle is accurately spouted out to the incident point, and the cooling can be carried out effectively.

According to the present invention, the optical crystal is cooled down by a cooling device and the cooling gas is cooled down by the cooling device. This makes it possible to increase the cooling effect.

According to the present invention, a tilted surface to guide the gas spouted out to the end surface is formed on an opposite side of the gas injection nozzle. As a result, the cooling gas is not stagnated, and this contributes to the increase of the cooling effect.

According to the present invention, the laser oscillation device has an enclosed structure enclosed by a cover, the cooling gas is an atmospheric gas filled within the cover, and there is provided a cooling gas circulator to suck the atmospheric gas and to eject the gas to the end surface of the optical crystal. This makes it possible to perform gas cooling on the end surface of the optical crystal in the laser oscillation device with the enclosed structure.

### BRIEF DESCRIPTION OF THE DRAWINGS

FIG. 1 is a schematical drawing of a first embodiment of the present invention;

FIG. 2 is a schematical drawing of a second embodiment of the present invention;

FIG. 3 is a schematical drawing of a third embodiment of the present invention;

FIG. 4 is a schematical drawing of a fourth embodiment of the present invention;

FIG. 5 is a cross-sectional view of an essential portion of a first concrete example of the present invention;

FIG. 6 is a cross-sectional view of a second concrete example of the present invention;

FIG. 7 is a schematical drawing of a laser oscillation device;

FIG. 8 is a schematical drawing to show a case where a light emitting unit of the laser oscillation device has a plurality of semiconductor lasers; and

FIG. 9 is a cross-sectional view of a conventional type laser oscillation device.

### DETAILED DESCRIPTION OF THE PREFERRED EMBODIMENTS

Description will be given below on the best mode of the present invention referring to the drawings.

According to the present invention, at an end surface of a laser crystal—in particular, at an incident point of an excitation light—heat is diffused and cooled down by gas flow.

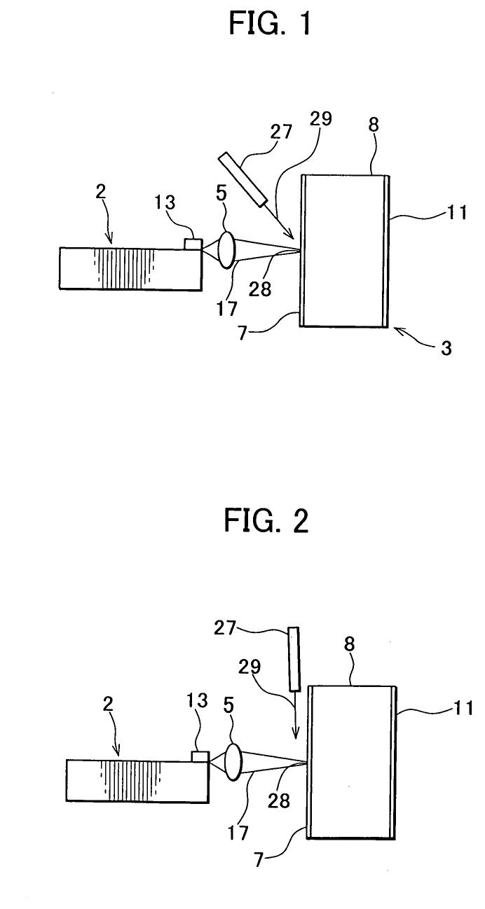

Referring to FIG. 1, description will be given now on general features of a first embodiment of the present invention.

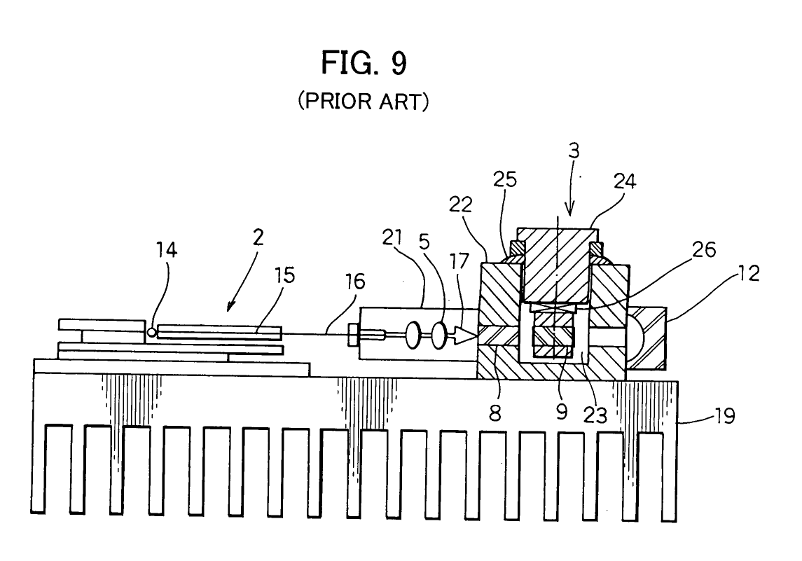

In FIG. 1, the same component as shown in FIG. 8 and FIG. 9 is referred by the same symbol.

An excitation light 17 is emitted from a semiconductor 13 or from a plurality of semiconductor lasers 13. The excitation light 17 is converged by a condenser lens 5 and enters an end surface of a laser crystal 8. On an end surface of the laser crystal 8 closer to the semiconductor laser 13, a first dielectric reflection film 7 is formed, which is highly transmissive to the excitation light 17 and is highly reflective to an oscillation wave of the laser crystal 8. On an end surface of the laser crystal 8 on the other side of the semiconductor laser 13, a second dielectric reflection film 11 is formed, which is highly transmissive to the oscillation wave. The laser crystal 8 fulfills a function as an optical resonator 3.

A gas injection nozzle 27 is provided in such manner as the gas injection nozzle 27 is tilted with respect to an optical axis of the excitation light 17, and a cooling gas 29 is spouted out from the gas injection nozzle 27 toward an incident point 28 on the end surface of the laser crystal 8. When the cooling gas 29 is spouted out to the incident point 28, the end surface of the laser crystal 8—in particular, the incident point 28—is cooled down.

It is preferable to use a clean and dried gas as the cooling gas 29. For instance, it is a nitrogen gas at low temperature which is evaporated from liquid nitrogen gas, or a clean air purified through an air filter. Or it is an atmospheric gas, etc. circulated through an air filter, a cooling system, etc. when the laser oscillation device is sealed in a nitrogen gas atmosphere.

When cooling is performed by spouting out the cooling gas 29, heat radiation characteristic is influenced by a flow amount and temperature of the cooling gas 29. Thus, the flow rate and temperature of the cooling gas 29 is determined according to an energy amount of the excitation light 17.

The cooling in the present invention may be applied to a laser oscillation device in which a composite crystal is made up by integrating the laser crystal 8 with the wavelength conversion crystal 9 and the laser oscillation device is constructed as an intracavity type SHG laser oscillation device so that the secondary higher harmonic wave is outputted.

FIG. 2 shows general features of a second embodiment of the present invention.

In some cases, a heat generating amount at the incident point 28 may be low depending on the laser output. In such case, the cooling gas 29 may not be spouted out to the incident point 28 and the gas in contact with the end surface of the laser crystal 8 may be moved as an air curtain.

The gas injection nozzle 27 is positioned in parallel to or approximately in parallel to the end surface of the laser crystal 8 and the cooling gas 29 is ejected to flow along the end surface of the laser crystal 8.

The gas injection nozzle 27 is required simply to spout out the cooling gas 29 so as to flow along the end surface of the laser crystal 8. Thus, there is no precise requirement on the accuracy of positioning of the gas injection nozzle 27, and fine positioning of the gas injection nozzle 27 is not needed. An eject outlet of the gas injection nozzle 27 may be designed in slit-like shape.

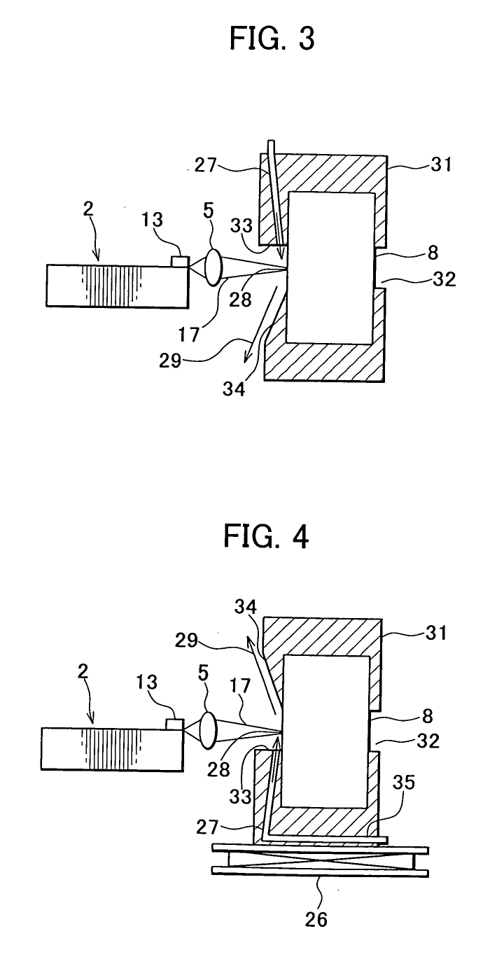

FIG. 3 shows a third embodiment of the present invention.

The third embodiment shows a case where the laser crystal 8 is held in an optical resonator block 31, which also serves as a heat sink, and the gas injection nozzle 27 is formed on the optical resonator block 31.

An optical path hole 32 is formed in the optical resonator block 31 so that a laser beam passes through the optical path hole 32. At an opening of the optical path hole 32 closer to the semiconductor laser 13, a perpendicular surface 33 running perpendicularly to the end surface of the laser crystal 8 is formed on one side. A tilted surface 34 is formed on the other side of the opening.

The gas injection nozzle 27 is formed in a portion of the optical resonator block 31 closer to the semiconductor laser 13 than the laser crystal 8. The gas injection nozzle 27 is tilted in such manner that the gas injection nozzle 27 comes closer to the end surface of the laser crystal 8. A forward end of the gas injection nozzle 27 is opened to the perpendicular surface 33, and a base end of the gas injection nozzle 27 is connected with a cooling gas supply unit (not shown).

Because the gas injection nozzle 27 is formed in the optical resonator block 31, there is no need to perform position adjustment for the gas injection nozzle 27, and the cooling gas 29 ejected from the gas injection nozzle 27 is perfectly spouted out to the incident point 28. The tilted surface 34 fulfills a function to rectify the flow of the cooling gas 29. The spouted cooling gas 29 is reflected by the end surface of the laser crystal 8. The cooling gas 29 flows out without being stagnated, and heat radiation at the incident point 28 is efficiently carried out by the cooling gas 29.

The laser crystal 8 is held on the optical resonator block 31, which serves as a heat sink, and heat is also radiated from the optical resonator block 31.

FIG. 4 shows general features of a fourth embodiment of the present invention.

In the fourth embodiment, a Peltier element 26, which is one of means for cooling, is provided on the optical resonator block 31, and the optical resonator block 31 and the Peltier element 26 make up together a cooling system. The optical resonator block 31 cools down the laser crystal 8 and the optical resonator block 31 also cools down the cooling gas 29 spouted out to the incident point 28.

Along a surface of the optical resonator block 31, which is in contact with the Peltier element 26, a cooling gas channel 35 is formed in the optical resonator block 31, and the cooling gas channel 35 is connected with the gas injection nozzle 27.

When the cooling gas 29 passes through the cooling gas channel 35, the cooling gas 29 is cooled down by the Peltier element 26, and the cooling gas 29 passes through the gas injection nozzle 27 and is spouted out to the incident point 28 of the laser crystal 8. When the cooling gas 29 thus cooled down is spouted out to the incident point 28, the amount of heat radiation from the incident point 28 increases, and this suppresses temperature rise at the incident point 28.

To cool down the cooling gas 29, a cooling unit may be separately furnished, and the gas cooled by the cooling unit may be spouted out from the gas injection nozzle 27.

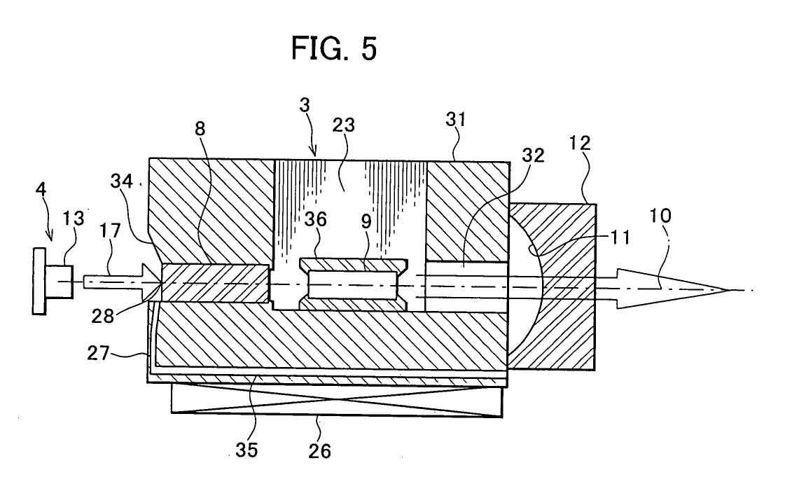

FIG. 5 is a drawing, which shows the fourth embodiment more concretely.

The recess 23 is formed on the optical resonator block 31, and the optical path hole 32 is formed in the optical resonator block 31 so that the optical path hole 32 crosses through the recess 23. On one portion of the optical path hole 32 divided by the recess 23, the laser crystal 8 is provided. The semiconductor laser 13 is arranged at a position to face to the laser crystal 8, and the concave mirror 12 is placed at a position to face to the other portion of the optical path hole 32. In the recess 23, the wavelength conversion crystal 9 is accommodated via a wavelength conversion crystal holder 36. The semiconductor laser 13, the laser crystal 8, the wavelength conversion crystal 9, the optical path hole 32, and the concave mirror 12 are arranged on an optical axis 10.

The Peltier element 26 is fixed on a bottom surface of the optical resonator block 31. The cooling gas channel 35 is provided along the Peltier element 26 in the optical resonator block 31. The gas injection nozzle 27 opened to an end portion of the optical path hole 32 closer to the semiconductor laser 13 is arranged, and the gas injection nozzle 27 is connected with the cooling gas channel 35.

On an end surface of the laser crystal 8 closer to the semiconductor laser 13, the first dielectric reflection film 7 is formed, which is highly transmissive to the excitation light 17 and is highly reflective to a fundamental wave oscillated at the optical resonator 3 and to a secondary higher harmonic wave with a wavelength converted by the wavelength conversion crystal 9. The second dielectric reflection film 11 on the concave mirror 12 is highly reflective to the fundamental wave and is highly transmissive to the secondary higher harmonic wave.

When the excitation light 17 enters the laser crystal 8 from the semiconductor laser 13, the excitation light 17 is oscillated by the laser crystal 8 and is pumped by the optical resonator 3. Then, its wavelength is converted by the wavelength conversion crystal 9 and the light is projected through the concave mirror 12.

The optical resonator block 31 is cooled down by the Peltier element 26. The wavelength conversion crystal 9 is cooled down by the optical resonator block 31 via the wavelength conversion crystal holder 36. The laser crystal 8 is cooled down by the optical resonator block 31.

The cooling gas passes through the cooling gas channel 35 and is cooled down by the Peltier element 26. The cooling gas thus cooled down passes through the gas injection nozzle 27 and is spouted out to the end surface of the laser crystal 8. The incident point 28 is cooled down and temperature increase is suppressed.

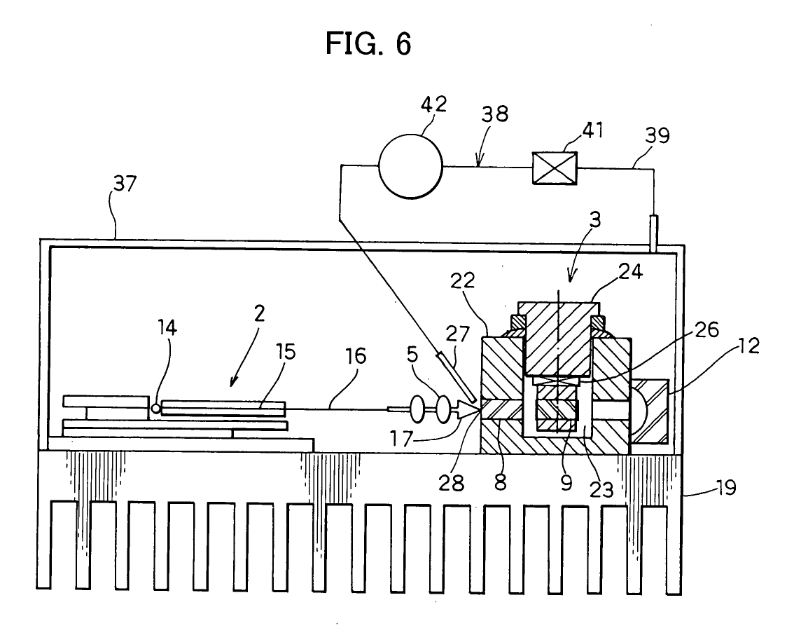

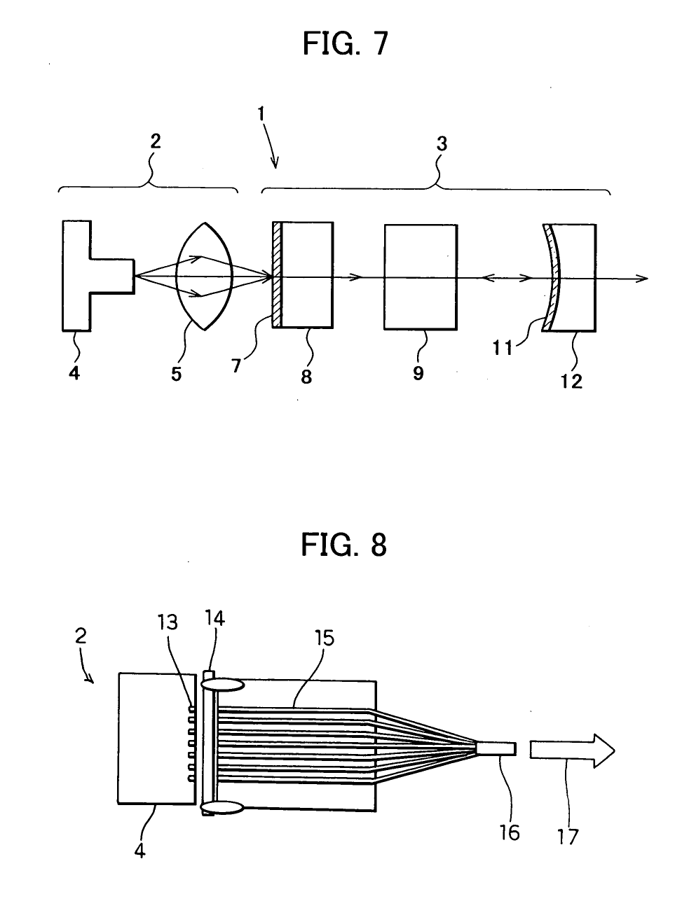

FIG. 6 shows another concrete example of the present invention. It represents a case where the laser oscillation device 1 is sealed in an enclosed container.

In FIG. 6, the same component as shown in FIG. 9 is referred by the same symbol, and detailed description is not given here.

A cover 37 for air-tightly enclosing the light emitting unit 2 and the optical resonator 3 is provided on the base 19, and nitrogen gas used as atmospheric gas is filled within the cover 37.

The gas injection nozzle 27 is arranged in such manner that the cooling gas is spouted out toward the incident point 28 of the excitation light 17 on the laser crystal 8, and a cooling gas circulator 38 is connected with the gas injection nozzle 27.

The cooling gas circulator 38 has a circulation line 39, which is communicated with the cover 37 at a position as required and is connected with the gas injection nozzle 27. An air filter 41 and a fan 42 are arranged on the circulation line 39.

When the fan 42 is driven, the nitrogen gas within the cover 37 is sucked. When the nitrogen gas passes through the air filter 41, dust and other objects are removed, and it is ejected through the gas injection nozzle 27 as the cooling gas. The cooling gas cools down the end surface of the laser crystal 8 and suppresses temperature rise. As shown in FIG. 4, the gas injection nozzle 27 may be formed on the optical resonator block 22. A heat radiator or a cooling device such as a Peltier element may be provided at the middle of the circulation line 39 to cool down the circulating nitrogen gas and to cool down the end surface of the laser crystal 8 and to suppress the rise of atmospheric temperature within the cover 37.

1. A laser oscillation device, comprising an optical crystal, wherein an end surface of said optical crystal where a laser beam enters is cooled down by a gas.

2. A laser oscillation device according to claim 1, wherein said cooling gas is spouted out to an incident point of the laser beam on said optical crystal.

3. A laser oscillation device according to claim 1, wherein the cooling gas is flowed along the end surface of said optical crystal.

4. A laser oscillation device according to claim 2 or 3, wherein the cooling gas is ejected through a gas injection nozzle.

5. A laser oscillation device according to claim 1, wherein said optical crystal is held by a block, and a gas injection nozzle to eject the cooling gas to the end surface of said optical crystal is formed in said block.

6. A laser oscillation device according to claim 1, wherein said optical crystal is cooled down by a cooling device and the cooling gas is cooled down by said cooling device.

7. A laser oscillation device according to claim 4, wherein a tilted surface to guide the gas spouted out to the end surface is formed on an opposite side of said gas injection nozzle.

8. A laser oscillation device according to claim 1, wherein said laser oscillation device has an enclosed structure enclosed by a cover, the cooling gas is an atmospheric gas filled within said cover, and there is provided a cooling gas circulator to suck the atmospheric gas and to eject the gas to the end surface of said optical crystal.
